(19) United States
(12) Patent Application Publication
(10) Pub. No.: US 2020/0200453 A1
(43) Pub. Date: Jun. 25, 2020

(54) Expansion Valve In Temperature Control Systems

(71) Applicant: Rheem Manufacturing Company, Atlanta, GA (US)

(72) Inventor: Brandon Moon, Fort Smith, AR (US)

(21) Appl. No.: 16/228,523

(22) Filed: Dec. 20, 2018

(51) Int. Cl. F25B 41/06; F16K 7/06

(52) U.S. Cl. CPC F25B 41/062; F16K 7/061

(57) ABSTRACT

An expansion valve includes a valve body that is designed as a converging-diverging nozzle that tapers from an inlet end and an outlet end thereof towards a throat. The valve body includes an inlet opening, an outlet opening, and a refrigerant flow path that are co-axial, the refrigerant flow path extending through the valve body from the inlet opening to the outlet opening. A portion of the valve body is flexible and configured to be adjusted by application of an external force to throttle the valve body at the throat and thereby control a flow of the refrigerant through the refrigerant flow path. Further, the expansion valve includes a force applying assembly that is coupled to the flexible portion of the valve body to apply the external force thereon. The force applying assembly is disposed external to the refrigerant flow path and removably coupled to the valve body.

### TECHNICAL FIELD

The present disclosure relates generally to temperature control systems, and more particularly to an improved expansion valve in temperature control systems, such as a heating, ventilating, air-conditioning, and refrigeration (HVACR) system.

### BACKGROUND

In a temperature control system, such as an HVACR system 100 (shown in FIG. 1) operating a compression refrigeration cycle 102, a refrigerant that is in a gaseous state is compressed by a compressor unit 104 and passed into a condenser unit 106 via a discharge tube 108. In the condenser unit 106, a heat exchange occurs with a cooling medium such as an airflow 110. The heat exchange lowers a temperature of the refrigerant, which in turn changes the refrigerant from the gaseous state to a liquid state. From the condenser unit 106, the liquid refrigerant, which is now at a high pressure, passes through an expansion valve 112 (also referred to as a ‘metering device’) to an evaporator unit 114 via a liquid line 116. As the refrigerant passes through the expansion valve 112, the refrigerant experiences a pressure drop and a resulting temperature drop. In the evaporator unit 114, another heat exchange occurs which raises a temperature of the refrigerant. The pressure drop and the heat exchange in the evaporator unit 114 cause the refrigerant to evaporate and thereby change back to the vapor state. The refrigerant in the vapor state then returns to the compressor unit 104 via a suction line 118.

In the HVACR system 100, the expansion valve 112 is used as a control device that is configured to control a flow rate of the high pressure liquid refrigerant from the condenser unit 106 to the evaporator unit 114 such that a two-phase refrigerant (mix of refrigerant in vapor state and liquid state) that is output from the expansion valve 112 flows through as much of the evaporator coil 120 of the evaporator unit 114 as possible without any liquid refrigerant being carried over to the compressor unit 104. Further, the expansion valve 112 is used to maintain a pressure difference between the condenser unit 106 (high pressure side) and the evaporator unit 114 (low pressure side). So, for the HVACR system 100 to operate properly, safely, and efficiently, the expansion valve 112 should precisely control the flow of refrigerant therethrough, in response to system conditions. However, existing expansion valves are prone to debris getting lodged therein and preventing the expansion valve from precisely controlling the flow of the high pressure liquid refrigerant to the evaporator unit 114. The debris may be present in the refrigerant and may include, but is not limited to copper chips or other similar material, that enter or get disposed in the refrigerant during installation, brazing of the various pipes of the HVACR system (liquid line, suction line, etc.), and so on. Further, in existing expansion valves, the electronics or mechanics that are associated with controlling the expansion valves are formed integrally within the expansion valves such that a removal or replacement of the electronics or mechanics associated with the existing expansion valves, which are prone to frequent failure, may require the entire expansion valve to be removed or replaced.

For example, as illustrated in FIGS. 2 and 3, an example conventional thermostatic expansion valve 200 and an example conventional electronic expansion valve 300 that are configured to control a flow rate of the refrigerant to an evaporator coil 120 may include a rigid body (202, 302) with a circuitous refrigerant flow path (205, 305) from an inlet (204, 304) (high pressure end) to an outlet (206, 306) (low pressure end). That is, in the example conventional expansion valves (200, 300), the inlet (204, 304) and the outlet (206, 306) are offset on different planes such that the path (205, 305) of the refrigerant flow is not linear and has to be re-directed from the inlet (104, 204) to the outlet (106, 206) by sharp turns and twists. Further, as illustrated in FIGS. 2 and 3, the electronics 310 and mechanics (212, 312) of the example conventional expansion valves (200, 300) are integrally formed within the rigid housing (202, 302) and/or in the flow path (205, 305) of the refrigerant in the example conventional expansion valves (200, 300). The rigid body (202, 302), the re-directed flow path (i.e., non-linear flow path), and the positioning of the electronics 310 and/or mechanics (212, 312) within the refrigerant flow path (205, 305) of the example conventional expansion valves (200, 300) make them prone to debris being lodged therein (i.e., within the rigid body, in corners along the non-linear flow path, in the mechanics, in between components disposed in the refrigerant flow path, etc.) and resulting in preventing a throttling of the expansion valves (200, 300). Further, since the electronics 310 and/or the mechanics (212, 312) are integrally formed with the expansion valves (100, 200), when the electronics 310 and/or the mechanics (212, 312) of the example conventional expansion valves (200, 300) fail, the expansion valves (200, 300) have to be removed or replaced as a whole even if other components of the expansion valve (200, 300), such as the seat (216, 316), pin (218, 318), the spring 214, etc., of the expansion valves (200, 300) have not failed.

It is noted that this background information is provided to reveal information believed by the applicant to be of possible relevance to the present disclosure. No admission is necessarily intended, nor should be construed, that any of the preceding information constitutes prior art against the present disclosure.

### SUMMARY

In one aspect, the present disclosure is directed to an expansion valve that includes a valve body that defines a longitudinal cavity that extends therethrough and tapers from an inlet opening defined by an inlet end of the valve body towards a constricting point and tapers from an outlet opening defined by an outlet end of the valve body towards the constricting point. The constricting point is disposed between the inlet opening defined by the inlet end and the outlet opening defined by the outlet end. A portion of the valve body is adjustable to throttle the longitudinal cavity at the constricting point to control a flow of the refrigerant through the refrigerant flow path. Further, the expansion valve includes a force applying assembly that is disposed external to the longitudinal cavity. The force applying assembly is removably coupled to the portion of the valve body that is adjustable to apply an external force thereto to throttle the longitudinal cavity at the constricting point.

In another aspect, the present disclosure is directed to a metering device that includes a valve body that is configured as a converging-diverging nozzle such that the valve body tapers from an inlet of the valve body towards a throat and tapers from an outlet of the valve body towards the throat. The throat is disposed between the inlet and the outlet. The valve body defines a refrigerant flow path that extends therethrough and tapers from an inlet opening at the inlet towards a constricting point and tapers from an outlet opening at the outlet towards the constricting point. The constricting point is located where the refrigerant flow path is narrowest and is defined by the throat of the valve body. Further, the inlet opening, the outlet opening, and the refrigerant flow path are co-axial. Furthermore, a portion of the valve body is adjustable to throttle the valve body at the throat and thereby throttle the refrigerant flow path at the constricting point to control a flow of the refrigerant through the refrigerant flow path.

In yet another aspect, the present disclosure is directed to a temperature control system that includes an expansion valve that is coupled to a condenser unit of the temperature control system at an inlet of the expansion valve and to an evaporator unit at an outlet of the expansion valve. The expansion valve includes a valve body that defines a longitudinal cavity that extends therethrough and tapers from an inlet opening defined by the inlet of the valve body towards a constricting point and tapers from an outlet opening defined by the outlet of the valve body towards the constricting point. The constricting point is disposed between the inlet opening and the outlet opening. A portion of the valve body is adjustable to throttle the longitudinal cavity at the constricting point to control a flow of the refrigerant through the refrigerant flow path. Further, the expansion valve includes a force applying assembly that is disposed external to the longitudinal cavity and is removably coupled to the portion of the valve body that is adjustable to apply an external force thereto to throttle the longitudinal cavity at the constricting point.

These and other aspects, objects, features, and embodiments, will be apparent from the following description and the appended claims.

### BRIEF DESCRIPTION OF THE FIGURES

The foregoing and other features and aspects of the present disclosure are best understood with reference to the following description of certain example embodiments, when read in conjunction with the accompanying drawings, wherein:

FIG. 1 illustrates a schematic diagram of an example compression refrigeration cycle of an HVACR system, in accordance with example embodiments of the present disclosure;

FIG. 2 illustrates a perspective view of a thermostatic expansion valve, in accordance with a prior art system;

FIG. 3 illustrates a perspective view of an electronic expansion valve, in accordance with a prior art system;

FIG. 4 illustrates a front view of a first example embodiment of an expansion valve in the Y-Z plane, in accordance with example embodiments of the present disclosure; and

FIG. 5 illustrates a cross-sectional side view of the first example embodiment of the expansion valve of FIG. 4 along the X-Y plane, in accordance with example embodiments of the present disclosure.

The drawings illustrate only example embodiments of the present disclosure and are therefore not to be considered limiting of its scope, as the present disclosure may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles.

### DETAILED DESCRIPTION OF EXAMPLE EMBODIMENTS

The present disclosure describes an example metering device (hereinafter ‘expansion valve’) of a temperature control system, such as a heating, ventilating, air-conditioning, and refrigeration (HVACR) system. The example expansion valve of the present disclosure includes a valve body that is disposed in a valve housing. The valve body is configured as a converging-diverging nozzle having a longitudinal refrigerant flow path extending therethrough that minimizes re-direction of or obstructions in the refrigerant flow path from inlet to outlet of the expansion valve. The minimized re-direction or obstruction of the refrigerant along the refrigerant flow path reduces a risk of debris being lodged in the refrigerant flow path and preventing the expansion valve from precisely controlling the flow of the high pressure liquid refrigerant to the evaporator unit 114. Further, the example expansion valve includes electronics and/or mechanics that are coupled to the valve body and configured to control a flow of a refrigerant through the valve body by an applying externally driven force on a portion of the valve body that is flexible or adjustable (e.g., vertically adjustable). The electronics and/or mechanics associated with the expansion valve are disposed in an electronics housing that is removably coupled to the valve body. The electronics and/or mechanics are removably coupled to the valve body and disposed in the electronics housing such that the electronics and/or the mechanics are external to the refrigerant flow path and can be replaced without removing or replacing the expansion valve as a whole.

Example embodiments of the expansion valve will be described more fully hereinafter with reference to the accompanying drawings that describe representative embodiments of the present technology. If a component of a figure is described but not expressly shown or labeled in that figure, the label used for a corresponding component in another figure can be inferred to that component. Conversely, if a component in a figure is labeled but not described, the description for such component can be substantially the same as the description for a corresponding component in another figure. Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

The technology of the expansion valve of the present disclosure may be embodied in many different forms (e.g., thermostatic valve, electronic valve, etc.) and should not be construed as limited to the embodiments set forth herein; rather, these embodiments are provided so that this disclosure will be thorough and complete, and will fully convey the scope of the technology to those appropriately skilled in the art. Further, example embodiments of the expansion valve of the present disclosure can be disposed in a heating, air-conditioning, and/or refrigeration system that is located in any type of environment (e.g., warehouse, attic, garage, storage, mechanical room, basement) for any type (e.g., commercial, residential, industrial) of user. Further, even though the present disclosure describes the expansion valve as being used in and disposed between a condenser and an evaporator of a refrigeration system, one of skill in the art can understand and appreciate that the application of the expansion valve is not limited to refrigeration systems. That is, in other example embodiments, the expansion valve can be used in any other appropriate application or system that requires or can benefit from the functionality of the expansion valve (or metering device), i.e., changing a pressure and/or controlling a flow rate of a matter flowing therethrough, without departing from a broader scope of the present disclosure.

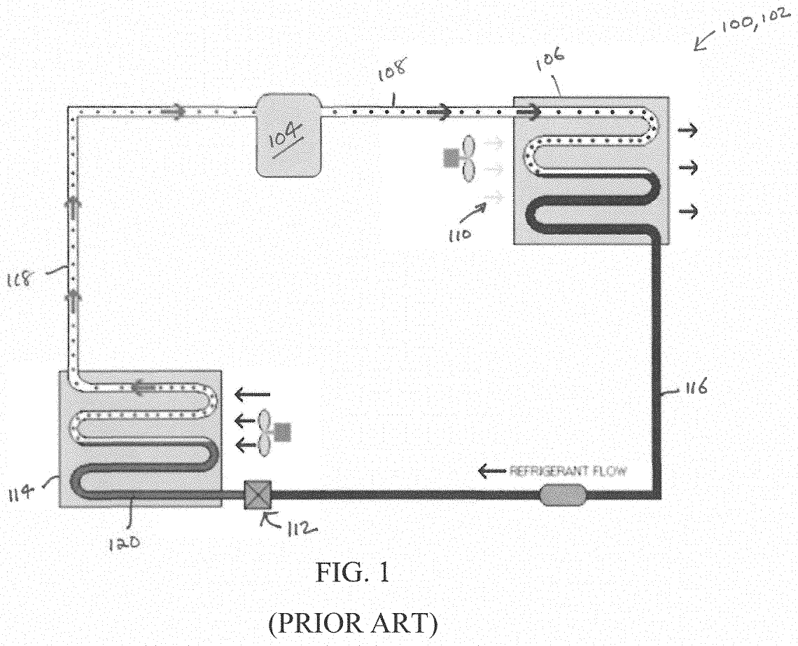

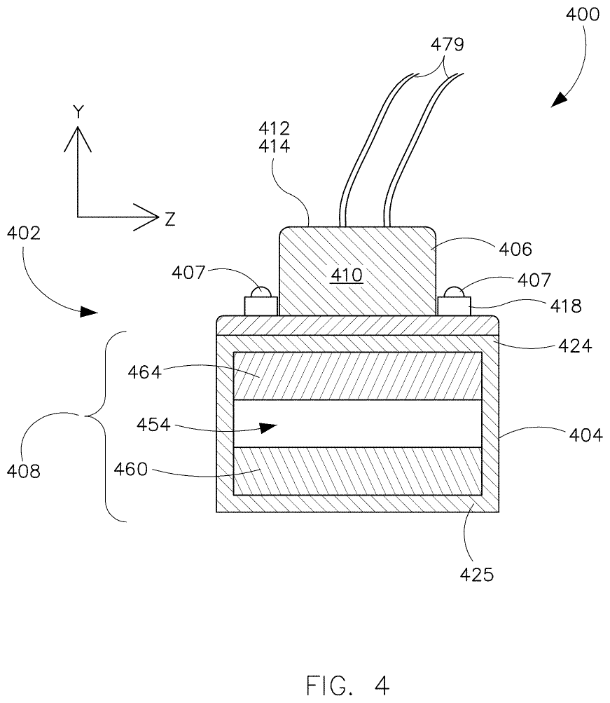

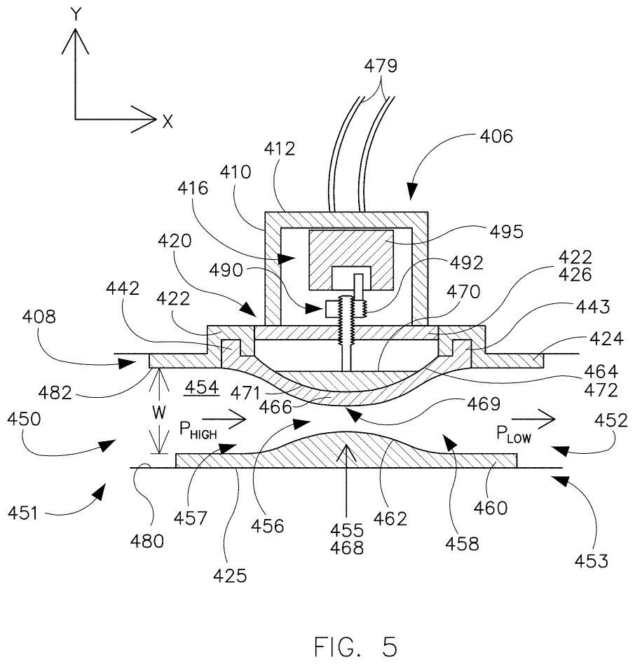

Turning now to the figures, example embodiments of an expansion valve will be described in connection with FIGS. 4-5. The expansion valve 400 of the present disclosure that is illustrated in FIGS. 4-5 is a new and novel expansion valve (or metering device) that is distinguishable from and provides improvements over the prior art metering devices 112 or expansion valves 200, 300 illustrated in FIGS. 1-3.

Referring to FIGS. 4-5, an example expansion valve 400 may include a housing assembly 402 that comprises a valve housing 404 and an electronics housing 406 that is removably coupled to the valve housing 404. In one example embodiment, the electronics housing 406 may be coupled to the valve housing 404 using fasteners, such as screws 407, rivets, etc. However, in other example embodiments, the electronics housing 406 may be coupled to the valve housing 404 using any other appropriate removable coupling means without departing from a broader scope of the present disclosure.

In the example embodiment illustrated in FIG. 5, the electronics housing 406 may include a side wall 410 and a top wall 412 that is disposed at the top edge 414 of the side wall 410 and arranged such that the side wall 410 in combination with the top wall 412 defines an inner cavity 416. Further, the electronics housing 406 may include side flanges 418 that extend out from a bottom edge 420 of the side wall 410. The side flanges 418 may include coupling apertures (not shown) that are formed therein and configured to receive fasteners, such as screws 407, rivets, etc., therethrough to removably couple the electronics housing 406 to the valve housing 404. The valve housing 404 may include corresponding mounting features 422 that are formed therein to removably mount the electronics housing 406 to the valve housing 404. For example, as illustrated in FIG. 5, the top wall 424 of the valve housing 404 may include a raised portion 426 having mounting holes (not shown) that are configured to align with the coupling apertures of the electronics housing 406 to receive the fasteners therethough to removably couple the electronics housing 406 to the valve housing 404 such that the inner cavity 416 defined by the electronics housing 406 may be enclosed by the top wall 424 of the valve housing 404.

It is noted that the shape and design of the valve housing 404 and the electronics housing 406 as illustrated in FIG. 5 and as described above are examples, and are not limiting. That is, one of skill in the art can understand and appreciate that in other example embodiments, the valve housing and the electronics housing may have any other appropriate shape and coupling mechanisms that allow the electronics housing to be removably coupled to the valve housing such that the electronics and/or mechanics associated with the expansion valve are coupled to a valve body that defines a refrigerant flow path and are disposed external to the refrigerant flow path, without departing from a broader scope of the present disclosure.

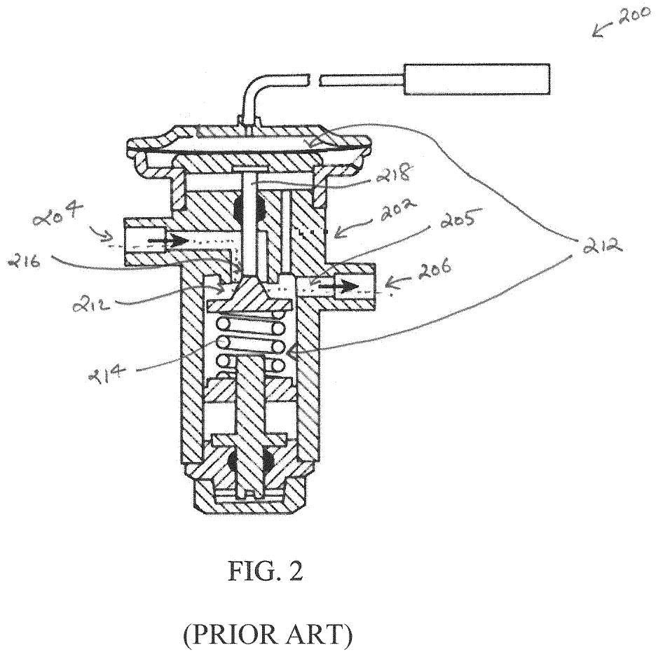

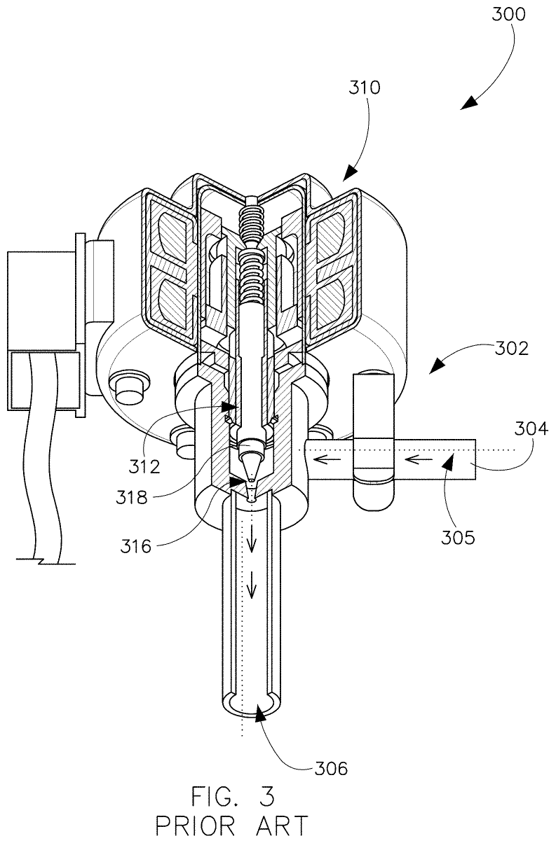

As illustrated in FIGS. 4-5, the valve housing 404 may be configured to house a valve body 408 therein. In particular, the valve body 408 may include an inlet opening 450 at an inlet end 451, an outlet opening 452 at an outlet end 453 that is disposed opposite to the inlet end 451, and a refrigerant flow cavity 454 (hereinafter ‘refrigerant flow path 454’) that extends from the inlet opening 450 at the inlet end 451 to the outlet opening 452 at the outlet end 453. The inlet opening 450 at the inlet end 451 and the outlet opening 452 at the outlet end 453 may be positioned such that they are in the same plane and/or are axially aligned with each other such that a refrigerant flow path 454 of the valve 408 is linear. In other words, the refrigerant flow path 454, the inlet opening 450, and the outlet opening 452 may be co-axial. Accordingly, the refrigerant flow path 454 of the expansion valve 400 of the present disclosure does not re-direct the flow of the refrigerant from an inlet opening to an outlet opening as in the circuitous refrigerant flow path (205, 305) of the conventional expansion valves (200, 300) illustrated in FIGS. 2-3, thereby providing a smooth refrigerant flow in comparison to the conventional expansion valves (200, 300).

Further, the valve body 408 of the expansion valve 400 may be configured as a converging-diverging nozzle as illustrated in FIG. 5, where the valve body 408 tapers from the inlet end 451 towards a throat 455 and tapers from the outlet end 453 towards the throat 455. The throat 455 is positioned approximately at the center of the valve body 408 such that the converging segment 457 and the diverging segment 458 of the valve body 408 may be substantially symmetrical. In other words, the valve body 408 may be configured such that a width ‘w’ of the refrigerant flow path 454 that extends through the valve body 408 may taper (e.g., reduce) from the inlet opening 450 and the outlet opening 452 towards a vena contracta point or constriction point 456 of the refrigerant flow path 454 that is defined by the throat 455. The terms ‘vena contracta point’ and ‘constriction point’ as used herein generally refer to the narrowest region or section of the refrigerant flow stream 454 where the width ‘w’ of the refrigerant flow stream 454 is the least. Further, the term ‘vena contracta point’ and ‘constriction point’ may be interchangeably used herein.

In one example embodiment, as illustrated in FIGS. 4-5, the valve body 408 and the refrigerant flow path 454 that extends therethrough may be defined by a first elongate member 460 that comprises a first curved segment 462 and a second elongate member 464 that comprises a second curved segment 466. The first elongate member 460 may be fixedly coupled to an inner surface 480 of the bottom wall 425 of the valve housing 404 and the second elongate member 462 may be fixedly coupled to an inner surface 482 of the top wall 424 of the valve housing 404 such that: (a) the first curved segment 462 and the second curved segment 466 face each other to define the throat 455 of the valve body 408, and (b) an apex 468 of the first curved segment 464 and an apex 469 of the second curved segment 466 face each other to define the constriction point 456 of the refrigerant flow path 454.

In the example embodiment illustrated in FIGS. 4-5, the second elongate member 464 may include a planar flexible membrane 472. The ends (442, 443) of the planar flexible membrane 472 may be fixedly coupled to the top wall 424 of the valve housing 404. The second curved segment 466 of the second flexible member 472 may be defined by a portion of the planar flexible membrane 472 (hereinafter ‘flexible membrane 472’) that is disposed on a curved driving block 470 that is vertically movable upon application of an external force. In other words, the flexible membrane 472 and the curved driving block 470 may be arranged such that a portion of the flexible membrane 472 is disposed on a curved surface 471 of the curved driving block 470 and assumes the shape of the curved surface 471 of the curved driving block 470 to define the second curved segment 466 of the second elongate member 464, as illustrated in FIG. 5.

In one example, the flexible membrane 472 may be a flexible silicone membrane, however, in other example embodiments, the flexible membrane 472 may be formed using any other appropriate material that can withstand the temperature of the refrigerant flowing through the refrigerant flow path 454 of the expansion valve 400 without departing from a broader scope of the present disclosure.

In particular, the flexible membrane 472 may be disposed over the curved driving block 470 such that the flexible membrane 472 is positioned between the refrigerant flow path 454 and the curved driving block 470 and a portion of the top wall 424 adjacent the curved driving block 470 to which the flexible membrane 472 is coupled. That is, the flexible membrane 472 may be disposed in the valve body 408 such that a refrigerant flowing through the valve body 408 along the refrigerant flow path 454 may engage the flexible membrane 472 and not the curved driving block 470 to provide a smooth flow surface, which reduces or minimizes the proclivity of debris to get lodged and stuck in the refrigerant flow path 454 and cause unintended obstructions to the flow of refrigerant therethrough.

In one example embodiment, the first curved segment 462 of the first elongate member 460 and the curved driving block 470 that defines the shape of the second curved segment 466 of the second elongate member 464 may be either U-shaped or V-shaped. However, in other example embodiments, the first curved segment 462 and the curved surface 471 of the curved driving block 470 that defines the shape of the second curved segment 466 may have any other appropriate shape that enables the formation of the throat 455 of the valve body 408 and the constriction point 456 in the refrigerant flow path 454 as illustrated in FIG. 5, i.e., when they are disposed such that they face each other to define the converging-diverging nozzle shape.

The curved driving block 470 may be a component of a driving assembly 490 that is configured to apply the external force to the curved driving block 470 to control a rate of flow of refrigerant through the expansion valve 400 based on superheat characteristics of the refrigerant exiting the evaporator unit 114, i.e., a change between refrigerant temperature or equivalent pressure in the evaporator coil 120 and temperature of the refrigerant exiting the evaporator coil 120. In particular, the curved driving block 470 may be movable between a default position (shown in FIG. 5) and a constricting position (not shown) by application of an external force thereto, to control a rate of flow of the refrigerant through the expansion valve 400 and to the evaporator unit 114. In the constricting position, the curved driving block 470 (or the apex thereof) and the second curved portion 466 of the second elongate member 464 (or apex 469 thereof) may be closer to the first curved segment 462 (or apex 468 thereof) of the first elongate member 460 than when the curved driving block 470 is at its default position. In other words, in the constricting position of the curved driving block 470, a width of the refrigerant flow path 454 at the constriction point 456 is further reduced than when the curved driving block 472 is in the default position, thereby further throttling a flow of the refrigerant through the refrigerant flow path 454.

As the curved driving block 470 is moved from the default position to the constricting position, the flexible membrane 472 that is coupled to the top wall 424 of the valve housing 404 and disposed on and across the curved surface 471 of the curved driving block 470 may flex to accommodate or adjust to the constricting position of the curved driving block 470, while the ends of the flexible membrane 472 still remain attached or coupled to the top wall 424. That is, when the curved driving block 470 is moved from the default position to the constricting position, the flexible membrane 472 stretches from its default position so that the portion of the flexible membrane 472 that is disposed on the curved surface 471 of the curved driving block 470 remains disposed on and in contact with the curved driving block 470. Similarly, when the curved driving block 470 moves back to the default position, the flexible membrane 472 disposed over and across the curved driving block 472 may revert back along with the curved driving block 470 such that the flexible membrane 472 remains disposed on and in contact with the curved driving block 470.

By the application of the external force on the curved driving block 470 and thereby on the flexible membrane 470, the throat 455 of the valve body 408 that is defined by the curved driving block 470, the portion of the flexible membrane 472 disposed over and across the curved driving block 470, and the first curved segment 462 of the first elongate member 460 may be throttled. Throttling the throat 455 of the valve body 408 may in turn reduce the width of the refrigerant flow path 454 at the constriction point 456 of the refrigerant flow path 454 that is defined by the throat 455 to control a rate of flow of the refrigerant through the expansion valve 400 and to the evaporator unit 114. In other words, second elongate member 464 of the valve body 408 may be configured to be adjustable or flexible such that an external force applied to the second elongate member 464 may cause the valve body 408 to be throttled at the throat 455 of the valve body 408 that is defined by the first curved segment 462 of the first elongate member 460 and the second curved portion 466 of the second elongate member 464.

In one example embodiment, as illustrated in FIG. 5, the external force may be applied to the second elongate member 464 of the valve body 408 by an actuator 495 that may be disposed in the electronics housing 406. The actuator 495 may be coupled to the second elongate member 464 via the driving assembly 490. In one example, the driving assembly 490 may include the curved driving block 470 that is disposed in the valve housing 404 and a driving pin 492 that is coupled to the curved driving block 470 at one end and to the actuator 495 at the opposite end. The driving pin 492 may extend from the curved driving block 470 disposed in the valve housing 404 to the actuator 495 disposed in the electronics housing 406 through a through hole formed in the top wall 424 of the valve housing 404. In other examples, the driving assembly 490 may include fewer or more components that are configured to couple the actuator 495 to the second elongate member 464 of the valve body 408 and cause the actuator 495 to adjust or flex the second elongate member 464 to control the flow of refrigerant through the expansion valve 400. For example, in some embodiments, in addition to the driving pin 492 and the curved driving block 470, the driving assembly 490 may include cams, gears, etc.

The driving pin 492 may include, but is not limited to a rod, a threaded screw or rod, etc. Further, the actuator 495 may include, but is not limited to, a solenoid, a stepper motor, a servomotor, etc. The electronics housing 406 may include a routing hole to route electrical wires 479 from a controller (not shown) to the actuator 495. The actuator 495 may receive control signals from the controller based on superheat characteristics of the refrigerant that is measured by sensors at the output of the evaporator unit 114 (i.e., in the suction line 118). On the basis of the control signals, the actuators 495 may be configured to apply an external force on the second elongate member 464 to throttle the valve body 408 and control the flow of refrigerant through the refrigerant flow path of the valve body 408.

The actuator 495 of the example embodiment of FIG. 5, may be removably coupled to the driving assembly 490, particularly to the driving pin 492. In some example embodiments, the driving pin 492 may also be removably coupled to the curved driving block 470. That is, the electronics and mechanics (492 and/or 495) associated with the expansion valve 400 may be removed or separated from the valve body 408 of the expansion valve 400. Further, as illustrated in FIG. 5, the electronics and mechanics, i.e., the actuator 495 and the driving assembly 490 associated with the expansion valve 400 may be disposed external to the refrigerant flow path 454. Disposing the electronics and mechanics (492 and/or 495) external to the refrigerant flow path 454 and the ability to remove or separate the electronics and mechanics (492 and/or 495) from the valve housing 404 and/or the valve body 408 allows the electronics and/or mechanics associated with the expansion valve 400 to be replaced (when they fail) without having to replace the expansion valve as a whole. That is, when the actuator 495 fails, a user may open the electronics housing 406 to expose the actuator 495 disposed therein. Then, the user may remove and replace the failed actuator 495 with a new actuator 495 without having to replace the expansion valve 400 as a whole, especially if the valve body 408 of the expansion valve 400 is functioning properly. After replacing the failed actuator with the new actuator, the user may re-attach the electronics housing 406 to the valve housing 404 to enclose the actuator 495 within the electronics housing 406.

Further, disposing the electronics and mechanics (492 and/or 495) associated with the expansion valve 400 external to the refrigerant flow path 454 thereof reduces or minimizes the proclivity of debris to get lodged or stuck in the refrigerant flow path 454. However, if debris does get lodged in the refrigerant flow path 454, for example, at the constricting point 456 of the refrigerant flow path 454 that is defined by the throat 455 of the valve body 408, the second elongate member 464 of the valve body 408 that is flexible may be adjusted automatically or manually (or partly automatically and partly mechanically) to expand the throat 455 and widen the refrigerant flow path 454 at the constricting point 456 to allow the debris to flow past the constricting point 456 and out through the outlet opening 452 of the valve body 408. In one example, to manually adjust the second elongated member 464 when debris gets stuck in the refrigerant flow path 454, a user may open the electronics housing 406 and remove the actuator 495 disposed therein to expose the driving pin 492 of the driving assembly 490. Further, in said example, the user may rotate or twist the driving pin 492 manually either clockwise or anticlockwise to open up or expand the refrigerant flow path 454 at the narrowest section 466, e.g., using a screwdriver (provided the driving pin has a head with indentation to receive the tip of the screwdriver).

In another example, to automatically adjust the second elongated member 464, the expansion valve 400 may include sensors (not shown) that are configured to detect the presence of debris obstructing the refrigerant flow path based on a pressure difference or difference in the speed of refrigerant flow at the inlet end 451 and the outlet end 453 of the expansion valve 400. In some examples, the flexible membrane 472 may also be configured to operate as a sensor that detects the presence of debris obstructing the refrigerant flow path 454. Responsive to detecting the presence of debris obstructing the refrigerant flow path 454, the actuator 495 may receive control signals from the controller to adjust the second elongate member 464 of the valve body 408 to open up or expand the refrigerant flow path 454 at the constricting point 456 and to allow the debris to flow past the constricting point 456 and out through the outlet opening 452 of the valve body 408.

The smooth and linear refrigerant flow path 454 defined by the first elongate member 460 and the second elongate member 464 with minimal re-directions reduces or minimizes the risk of debris getting lodged and stuck in the refrigerant flow path 454, thereby providing a non-obstructive (by debris) or free flow path for the refrigerant through the expansion valve. Further, the positioning of the electronics and mechanics associated with driving the expansion valve 400 (i.e., adjusting the flexible second elongate member) external to the refrigerant flow path also contributes to reducing or minimizing the risk of debris getting lodged and stuck in the refrigerant flow path 454.

Even though FIGS. 4 and 5 illustrate an expansion valve of the present disclosure that is electronically controlled, one of skill in the art can understand and appreciate that the elongate second member of the expansion valve of the present disclosure may be controlled or vertically adjusted by any other appropriate other mechanism to throttle the flow of refrigerant through the expansion valve without departing from a broader scope of the present disclosure. For example, the expansion valve may be configured such that the elongate second member is adjusted using an assembly of a temperature sensing bulb with a refrigerant filled therein, a capillary tube, a diaphragm, and a driving pin as used in thermostatic expansion valves. That is, the curved driving block 470 and the second elongate member 472 disposed in the valve housing 404 may be vertically adjusted based on how the refrigerant inside the temperature sensing bulb reacts (expands or contracts) to the temperature of the refrigerant exiting the evaporator unit.

Further, even though FIGS. 4 and 5 illustrate an expansion valve having a valve housing and/or valve body that has a substantially square or rectangular shaped front profile (or cross-sectional profile along the Y-Z plane), one of skill in the art can understand and appreciate that in other example embodiments, the valve housing and/or valve body of the expansion valve may have any other appropriate shape without departing from a broader scope of the present disclosure. For example, the valve housing and/or valve body of the expansion valve may have a substantially annular shaped front profile (or cross-sectional profile along the Y-Z plane). That is, the valve body may be defined by a cylindrical tube that is pinched in the middle to define the throat such that the valve body defines a converging-diverging nozzle. The cylindrical tube may define a refrigerant flow path therethrough that tapers from opposite ends of the cylindrical tube towards the throat. Further, a portion of the cylindrical tube may be configured to be adjustable or flexible to throttle the throat of the nozzle by application of an external force.

In other words, an expansion valve of the present disclosure may comprise a valve body that is designed as a converging diverging nozzle having a refrigerant flow path therethrough, where a portion of the valve body is configured to be flexible such that the flexible portion can be moved or adjusted (e.g., vertically adjusted) by application of an external force to throttle the expansion valve at a throat of the nozzle to control a rate of flow of the refrigerant through the refrigerant flow path of the valve body. The external force for adjusting the flexible portion of the valve body may be applied by force applying assembly that is disposed outside the refrigerant flow path and removably coupled to the valve body.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An expansion valve comprising:
a valve body that defines a longitudinal cavity that extends therethrough and tapers from an inlet opening defined by an inlet end of the valve body towards a constricting point and tapers from an outlet opening defined by an outlet end of the valve body towards the constricting point, the constricting point being disposed between the inlet opening defined by the inlet end and the outlet opening defined by the outlet end,
wherein a portion of the valve body is adjustable to throttle the longitudinal cavity at the constricting point to control a flow of the refrigerant through the refrigerant flow path; and
a force applying assembly that is disposed external to the longitudinal cavity and that is removably coupled to the portion of the valve body that is adjustable to apply an external force thereto to throttle the longitudinal cavity at the constricting point.

2. The expansion valve of claim 1, wherein the portion of the valve body that is adjustable is a flexible membrane.

3. The expansion valve of claim 2, wherein the flexible membrane is a silicone membrane.

4. The expansion valve of claim 1, wherein the valve body is configured as a converging-diverging nozzle.

5. The expansion valve of claim 1, wherein the valve body comprises:
a first elongate member that comprises a planar base and a first curved segment that protrudes from the planar base; and
a second elongate member that defines the portion of the valve body that is adjustable, the second elongate member comprising a flexible membrane,
wherein a portion of the second elongate member is disposed on a curved surface of a curved driving block and defines a second curved segment, and
wherein the first elongate member and the second elongate member are disposed opposite to each other in a valve housing along with the curved driving block such that the first curved segment and the second curved segment face each other to define the constricting point of the longitudinal cavity.

6. The expansion valve of claim 5, wherein the curved driving block is coupled to the force applying assembly that is configured to apply the external force on the curved driving block and adjust the second elongate member to throttle the longitudinal cavity at the constricting point.

7. The expansion valve of claim 5:
wherein the curved driving block is adjustable between a default position and a constricting position by the application of the external force thereto,
wherein in the default position the portion of the second elongate member that is disposed on the curved driving block and the first elongate member are separated at the constricting point of the longitudinal cavity by a first distance and in the constricting position the portion of the second elongate member that is disposed on the curved driving block and the first elongate member are separated at the constricting point of the longitudinal cavity by a second distance, and
wherein the first distance is greater than the second distance.

8. The expansion valve of claim 5, wherein the first elongate member is fixedly coupled to the valve housing, and wherein the flexible membrane is fixedly coupled to the valve housing at the ends thereof such that a portion of the flexible membrane is disposed on the curved driving block while the ends of the flexible membrane are fixedly coupled to the valve housing.

9. The expansion valve of claim 1, wherein the force applying assembly comprises an actuator and a driving assembly that is removably coupled to the actuator, and wherein the driving assembly comprises a driving pin and a curved driving block that is coupled to the driving pin.

10. The expansion valve of claim 9, wherein the actuator is disposed in an electronics housing that is removably coupled to a valve housing that houses the valve body, wherein the curved driving block is disposed in the valve housing and coupled to the portion of the valve body that is flexible, and wherein the driving pin extends from the valve housing to the electronics housing, the driving pin being coupled to the curved driving block at one end and to the actuator at an opposite end.

11. The expansion valve of claim 9, wherein the actuator is a servomotor.

12. A metering device comprising:
a valve body that is configured as a converging-diverging nozzle such that the valve body tapers from an inlet of the valve body towards a throat and tapers from an outlet of the valve body towards the throat, the throat disposed between the inlet and the outlet,
wherein the valve body defines a refrigerant flow path that extends therethrough and tapers from an inlet opening at the inlet towards a constricting point and tapers from an outlet opening at the outlet towards the constricting point, the constricting point located where the refrigerant flow path is narrowest and being defined by the throat of the valve body,
wherein the inlet opening, the outlet opening, and the refrigerant flow path are co-axial, and
wherein a portion of the valve body is adjustable to throttle the valve body at the throat and thereby throttle the refrigerant flow path at the constricting point to control a flow of the refrigerant through the refrigerant flow path.

13. The metering device of claim 12, further comprising:
a force applying assembly that is disposed external to the refrigerant flow path and is removably coupled to the portion of the valve body that is adjustable to apply an external force thereto to throttle the refrigerant flow path at the constricting point.

14. The metering device of claim 12, wherein the portion of the valve body that is adjustable is a flexible membrane.

15. The metering device of claim 13, wherein the force applying assembly comprises an actuator.

16. A temperature control system comprising:
an expansion valve that is coupled to a condenser unit of the temperature control system at an inlet of the expansion valve and to an evaporator unit at an outlet of the expansion valve, wherein the expansion valve comprises:
a valve body that defines a longitudinal cavity that extends therethrough and tapers from an inlet opening defined by the inlet of the valve body towards a constricting point and tapers from an outlet opening defined by the outlet of the valve body towards the constricting point, the constricting point being disposed between the inlet opening and the outlet opening,
wherein a portion of the valve body is adjustable to throttle the longitudinal cavity at the constricting point to control a flow of the refrigerant through the refrigerant flow path; and
a force applying assembly that is disposed external to the longitudinal cavity and is removably coupled to the portion of the valve body that is adjustable to apply an external force thereto to throttle the longitudinal cavity at the constricting point.

17. The temperature control system of claim 16, wherein the temperature control system comprises a heating, ventilating, air-conditioning, and refrigeration (HVACR) system.

18. The temperature control system of claim 16, wherein the portion of the valve body that is adjustable is a flexible membrane.

19. The metering device of claim 16, wherein the force applying assembly comprises an actuator.

20. The metering device of claim 16, wherein the valve body is configured as a converging-diverging nozzle.
